(19) United States
(12) Patent Application Publication
(10) Pub. No.: US 2024/0097268 A1
(43) Pub. Date: Mar. 21, 2024

(54) BATTERY CELL ASSEMBLY AND BATTERY PACK

(71) Applicant: Zhuhai CosMX Power Supply Co., Ltd., Zhuhai City (CN)

(72) Inventors: Changquan LIN, Zhuhai City (CN); Jiadong Deng, Zhuhai City (CN); Guogao Yi, Zhuhai City (CN)

(21) Appl. No.: 18/525,630

(22) Filed: Nov. 30, 2023

Related U.S. Application Data
(63) Continuation of application No. PCT/CN2022/139545, filed on Dec. 16, 2022.

(30) Foreign Application Priority Data
Dec. 29, 2021 (CN) 2021233927818

(51) Int. Cl. H01M 50/291; H01M 50/242; H01M 50/293; H01M 50/51

(52) U.S. Cl. CPC H01M 50/291; H01M 50/242; H01M 50/293; H01M 50/51

(57) ABSTRACT

The present application provides a battery cell assembly and a battery pack. The battery cell assembly includes a bracket and several battery cell modules which are electrically connected with one another, where the bracket is arranged between two adjacent battery cell modules, the battery cell module comprises a plurality of single battery cells which is arranged side by side, and the plurality of single battery cells is electrically connected with one another. The present application provides a battery cell assembly and a battery pack, which can replace a lead-acid battery and meet the use requirements of supplying power to an automobile start-stop system.

### CROSS-REFERENCE TO RELATED APPLICATIONS

This application is a continuation of International Application No. PCT/CN2022/139545, filed on Dec. 16, 2022, which claims priority to Chinese Patent Application No. 202123392781.8, entitled “BATTERY CELL ASSEMBLY AND BATTERY PACK,” and filed with the China National Intellectual Property Administration on Dec. 29, 2021. The disclosures of the aforementioned applications are hereby incorporated by reference in their entireties.

### TECHNICAL FIELD

The present application relates to the technical field of batteries, and in particular, to a battery cell assembly and a battery pack.

### BACKGROUND

With the increasing popularity of automobiles, the performance of automobiles are paid more and more attention in the market. Automobiles generally have the function of starting and stopping. When the automobile starting-engine starts or the automobile is waiting for a traffic light, battery power supply is needed to ensure the normal start of the engine and the operation of on-board electrical appliances. The battery for automobile start-stop needs to provide a large current in a short time, and needs to have the function of charging for multiple times.

Traditional start and stop of an automobile is usually powered by lead-acid batteries, which are those whose electrodes are mainly made of lead and its oxides, and the electrolyte is sulfuric acid solution. The technology of lead-acid batteries is very mature one, however considering the environmental factors, many countries in Europe and America began to ban lead, which restricts the further development of lead-acid batteries as batteries for automobile start-stop. In addition, lead-acid batteries have the defects of low energy density and short life cycle due to charge-discharge at large current.

Therefore, it is urgent to develop a battery that can replace lead-acid battery and meet the needs of automobile start-stop.

### SUMMARY

The present application provides a battery cell assembly and a battery pack, which is able to replace a lead-acid battery and meet the use requirements of supplying power to an automobile start-stop system.

In order to achieve the above-mentioned purpose, the application provides a battery cell assembly, including a bracket and several battery cell modules that are electrically connected with each other, where the bracket is arranged between two adjacent battery cell modules, each battery cell module comprises a plurality of single battery cells arranged side by side, and the plurality of single battery cells are electrically connected with each other.

The present application provides a battery cell assembly, which provides a new idea for the power supply for automobile start-stop, and may replace lead-acid batteries so as to meet the use requirement of the power supply for an automobile start-stop system and conform to the development trend of the times. In the battery cell assembly provided by the present, a plurality of single battery cells are electrically connected to each other, a plurality of battery cell modules are electrically connected to each other, and the modular production mode may flexibly set the number of battery cell modules according to the use requirements, which can meet the requirement of the power supply for automobile start-stop and also has the advantages of a high degree of integration, convenience for automatic production, and higher product consistency and reliability.

In one possible embodiment, a height of the bracket is 7 mm to 10 mm lower than a height of a single battery cell.

The height of the bracket is 133 mm to 140 mm.

In one possible embodiment, the battery cell assembly further includes a protective frame wrapped around outer sides of the several battery cell modules, and an inner wall of the protective frame is bonded with the several battery cell modules by an adhesive.

In one possible embodiment, the battery cell assembly further includes buffer components, which are arranged between the battery cell module and the bracket, and between the battery cell module and the protective frame, and between two adjacent single battery cells, respectively.

In one possible embodiment, a compression distance of the buffer component is greater than an expansion distance of the battery cell module.

In one possible embodiment, the buffer component is a foam, and a thickness of the foam is 1.5 mm to 3 mm.

In one possible embodiment, the bracket is an aluminum bracket; and/or
an interior of the bracket is a hollow structure; and/or
a thickness of the bracket is 5 mm to 8 mm.

In one possible embodiment, the protective frame includes several end plates, and a surface of each of the end plates corresponding to the buffer component is provided with a reinforcing rib.

In one possible embodiment, the end plate is further provided with an open pore.

In one possible embodiment, a plurality of single battery cells is connected to each other in series through a lead row, and several battery cell modules are connected to each other in series through the lead row.

The present application further includes a battery pack including a box body and the above-mentioned battery cell assembly located inside the box body.

The present application provides a battery cell assembly and a battery pack, and the bracket is arranged between two adjacent battery cell modules, and the bracket can play a role in supporting and fixing the battery cell module, effectively reducing the vibration of the battery cell module.

The present application provides a battery cell assembly and a battery pack, and an interior of the bracket is a hollow structure, and a plurality of weight-reducing holes is provided in the bracket to reduce the weight of the bracket, thereby reducing the weight of the battery cell assembly.

The present application provides a battery cell assembly and a battery pack. Considering that the single battery cell will expand slightly due to heat generation during the charging and discharging process, resulting in an increase in the overall volume of a battery cell module, the arrangement of the buffer component may reserve a safe distance for the expansion between the single battery cells, improving safety of use.

In addition to the above-mentioned technical problems solved by the embodiments of the present application, the technical features constituting the technical solutions, and the beneficial effects brought by the technical features of these technical solutions, other technical problems than can be solved by the battery cell assembly and the battery pack provided by the embodiments of the present application, other technical features included in the technical solutions and beneficial effects brought by these technical features, will be further described in details in the embodiments.

### BRIEF DESCRIPTION OF DRAWINGS

In order to illustrate the technical solutions in the embodiments of the present application or in the prior art more clearly, the drawings required in the embodiments or in the prior art will be briefly introduced below. Obviously, the drawings in the following description are some embodiments of the present application. For the person skilled in the art, other drawings may be obtained based on these drawings without creative work.

FIG. 1 is a schematic diagram of an exploded structure of a battery cell assembly provided by an embodiment of the present application.

FIG. 2 is a schematic diagram of another exploded structure of a battery cell assembly provided by an embodiment of the present application.

FIG. 3 is a schematic diagram of a three-dimensional structure of a battery cell assembly provided by an embodiment of the present application.

FIG. 4 is a schematic diagram of an exploded structure of a battery pack provided by an embodiment of the present application.

FIG. 5 is a schematic diagram of a three-dimensional structure of a battery pack provided by an embodiment of the present application.

FIG. 6 is a schematic diagram of another three-dimensional structure of a battery cell assembly provided by an embodiment of the present application.

FIG. 7 is a top view of the structure in FIG. 3 of a battery cell assembly provided by an embodiment of the present application.

FIG. 8 is a front view of the structure in FIG. 3 of a battery cell assembly provided by an embodiment of the present application.

FIG. 9 is a left view of the structure in FIG. 3 of a battery cell assembly provided by an embodiment of the present application.

FIG. 10 is a right view of the structure in FIG. 3 of a battery cell assembly provided by an embodiment of the present application.

FIG. 11 is a bottom view of the structure in FIG. 3 of a battery cell assembly provided by an embodiment of the present application.

FIG. 12 is a front view of a front end plate of a battery cell assembly provided by an embodiment of the present application.

FIG. 13 is a schematic diagram of a three-dimensional structure of a front end plate of a battery cell assembly provided by an embodiment of the present application.

FIG. 14 is a right view of a front end plate of a battery cell assembly provided by an embodiment of the present application.

FIG. 15 is a top view of a front end plate of a battery cell assembly provided by an embodiment of the present application.

FIG. 16 is a front view of a first side end plate or a second side end plate of a battery cell assembly provided by an embodiment of the present application.

FIG. 17 is a schematic diagram of a three-dimensional structure of a first side end plate or a second side end plate of a battery cell assembly provided by an embodiment of the present application.

FIG. 18 is a left view of a first side end plate or a second side end plate of a battery cell assembly provided by an embodiment of the present application.

FIG. 19 is a top view of a first side end plate or a second side end plate of a battery cell assembly provided by an embodiment of the present application.

FIG. 20 is a schematic diagram of a three-dimensional structure of a bracket of a battery cell assembly provided by an embodiment of the present application.

FIG. 21 is a front view of a bracket of a battery cell assembly provided by an embodiment of the present application.

FIG. 22 is a top view of a bracket of a battery cell assembly provided by an embodiment of the present application.

FIG. 23 is a right view of a bracket of a battery cell assembly provided by an embodiment of the present application.

### DESCRIPTION OF REFERENCE SIGNS

10—box body;
11—bottom shell;
20—battery cell module;
21—single battery cell;
22—buffer component;
211—first tab;
212—second tab;
30—bracket;
31—weight-reducing hole;
40—protective frame;
41—end plate;
411—front end plate;
4111—first flanging;
4112—second flanging;
412—back end plate;
4121—third flanging;
4122—fourth flanging;
4123—fifth flanging;
413—first side end plate;
414—second side end plate;
4141—sixth flanging;
415—bottom end plate;
4151—seventh flanging;
50—tab frame plate;
416—open pore;
60—lead row;
417—reinforcing rib;
70—insulating plate;
80—upper cover;
81—terminal.

### DESCRIPTION OF EMBODIMENTS

In order to make the purpose, technical solutions and advantages of the present application clearer, the technical solutions in the present application will be clearly and completely described below in conjunction with the drawings of the present application. Obviously, the described embodiments is a part of the embodiments of the present application, but not all of them. Based on the embodiments of the present application, all the other embodiments obtained by the person skilled in the art without creative work fall within the protection scope of the present application.

Compared with ordinary batteries, the battery for automobile start-stop should respond immediately when the engine is started, and it needs to have a higher capacity to meet engine shutdown and the operation of in-vehicle electrical appliances, as well as a good deep discharge performance to meet the use requirements for frequent large-current discharge in a short term of the automobile start-stop system. Lead-acid batteries are generally used to supply power for starting or stopping an automobile. As many countries in Europe and America comply with the international trend of banning lead, the development of lead-acid batteries is hindered. Therefore, it is necessary to find new batteries to replace lead-acid batteries to meet the power supply demand for starting or stopping an automobile.

In view of the above background, in a battery cell assembly is provided by the present application, the structure of several battery cell modules electrically connected to each other enables the present application to provide a battery cell assembly, which can facilitate the realization of modular production, flexibly configure the number of battery cell modules according to use requirements, meet the power supply demand of providing larger current in a short time, and satisfy the power supply demand of starting or stopping an automobile.

The battery cell assembly and battery pack provided by the embodiments of the application are described below with reference to the drawings.

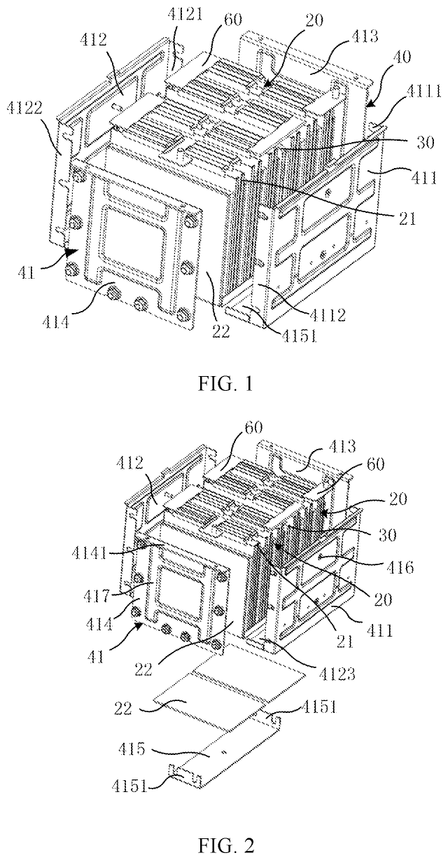

Referring to FIG. 1 and FIG. 2, the present application provides a battery cell assembly, which includes a bracket 30 and a plurality of battery cell modules 20 that are electrically connected to each other. The bracket 30 is arranged between two adjacent battery cell modules, and the battery cell module 20 includes a plurality of single battery cells 21 arranged side by side, and the plurality of single battery cells 21 is electrically connected to each other.

The battery cell assembly provided by the present application provides a new idea for the power supply for automobile start-stop, and may replace lead-acid batteries for the power supply for the automobile start-stop system, so as to conform to the development trend of the times. In the battery cell assembly provided by the present, a plurality of single battery cells 21 are electrically connected to each other, a plurality of battery cell modules 20 are electrically connected to each other, and the modular production mode may flexibly set the number of battery cell modules 20 according to the use requirements, which can meet the requirement of power supply of providing larger current in a short time, and the requirement of the power supply for automobile start-stop and also has the advantages of a high degree of integration, convenience for automatic production, and higher product consistency and reliability.

In addition, considering that the middle position of the battery cell assembly is the weakest, the present application provides a battery cell assembly, in which the bracket 30 is arranged between two adjacent battery cell modules 20 and can play a role in supporting and fixing the battery cell modules 20, effectively reducing the vibration of the battery cell modules 20.

In one possible embodiment, several battery cell modules 20 are electrically connected to each other, where several battery cell modules 20 may be connected to each other in series. In another possible embodiment, several battery cell modules 20 may also be connected to each other in parallel, or connected in series and in parallel.

In one possible embodiment, a plurality of single battery cells 21 is electrically connected to each other, where the plurality of single battery cells 21 may be connected to each other in series. In another possible embodiment, a plurality of single battery cells 21 may also be connected to each other in parallel, or connected in series and in parallel.

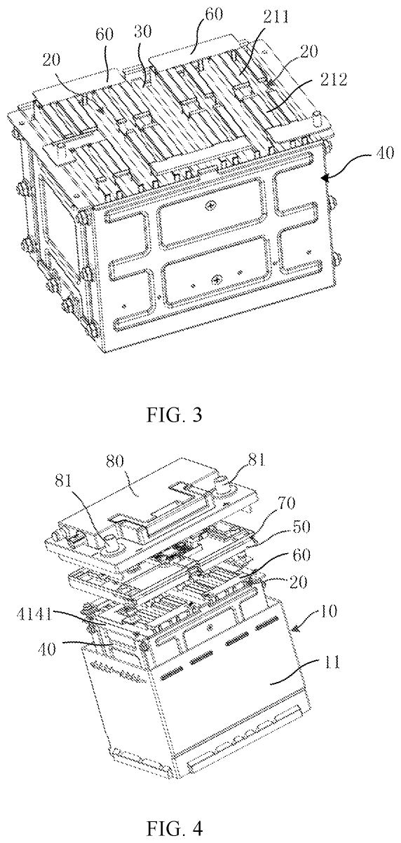

In one possible embodiment, as shown in FIGS. 2 and 3, a plurality of single battery cells 21 is connected to each other in series through lead row 60, and several battery cell modules 20 are connected to each other in series through lead row 60. The upper end of the single battery cell 21 has a first tab 211 and a second tab 212. After the first tab 211 and the second tab 212 are bent, the first tab 211 of a single battery cell 21 and the second tab 212 of another single battery cell 21 are connected in series by a plurality of lead rows 60, achieving the series connection of a plurality of single battery cells 21.

In one possible embodiment, the lead row 60 may be a copper row or an aluminum row.

In one possible embodiment, the single battery cell 21 is a lithium-ion battery cell.

The single battery cell 21 may include a positive electrode piece, a negative electrode piece, and a separator arranged between the positive electrode piece and the negative electrode piece that are adjacent to each other, which are stacked and then laminated in sequence. The separator prevents the positive electrode piece and the negative electrode piece from being contacted and short-circuited. In addition, the separator also has the function of allowing electrolyte ions in the electrolyte to pass through.

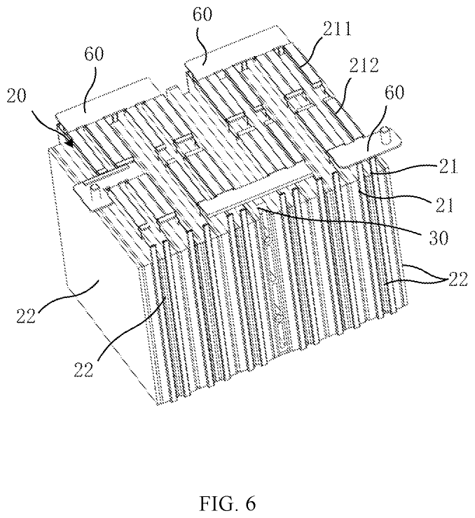

As shown in FIG. 6 and FIG. 7, the upper end of the single battery cell 21 is provided with the first tab 211 and the second tab 212, and one of the first tab 211 and the second tab 212 is a positive tab, and the other one of the first tab 211 and the second tab 212 is a negative tab. The positive tab is electrically connected to the positive electrode piece, and the negative tab is electrically connected to the negative electrode piece.

In one possible embodiment, the height of a bracket 30 is 7 mm to 10 mm lower than the height of a single battery cell 21, which may ensure that there is a certain height difference between the bracket 30 and the single battery cell 21, thereby preventing the bracket 30 from contacting the first tab 211 and the second tab 212 on the single battery cell 21, and improving safety of use.

In one possible embodiment, the height of the bracket 30 is 7 mm, 8 mm, 9 mm or 10 mm lower than the height of the single battery cell 21.

In one possible embodiment, as shown in FIG. 2, the battery cell assembly provided by the present embodiment further includes buffer components 22, which are respectively arranged between the battery cell module 20 and the bracket 30, and between the battery cell module 20 and a protective frame 40, and between two adjacent single battery cells 21.

In one possible embodiment, the compression distance of the buffer component 22 is greater than the expansion distance of a battery cell module 20. During the charging and discharging process, the single battery cell 21 will expand slightly due to heat generation, resulting in an increase in the overall volume of a battery cell module 20. The arrangement of the buffer component 22 may reserve a safe distance for the expansion between the single battery cells 21, improving safety of use.

In one possible embodiment, the buffer component 22 is a foam, and the compression amount of the foam is 60%.

In one possible embodiment, the thickness of the foam is 1.5 mm to 3 mm.

In one possible embodiment, the thickness of the foam is 1.5 mm, 2 mm, 2.5 mm or 3 mm.

In one possible embodiment, as shown in FIG. 20 and FIG. 23, the height H of the bracket 30 may be 133 mm to 140 mm.

In one possible embodiment, the height H of the bracket 30 may be 133 mm, 135 mm, 138 mm or 140 mm.

In one possible embodiment, the bracket 30 is an aluminum bracket, and as shown in FIG. 20 and FIG. 21, the thickness T of the bracket 30 is 5 mm to 8 mm.

The thickness of the bracket 30 cannot be too small or too large, for example, the thickness T of the bracket 30 may be 5 mm, 6 mm, 7 mm or 8 mm.

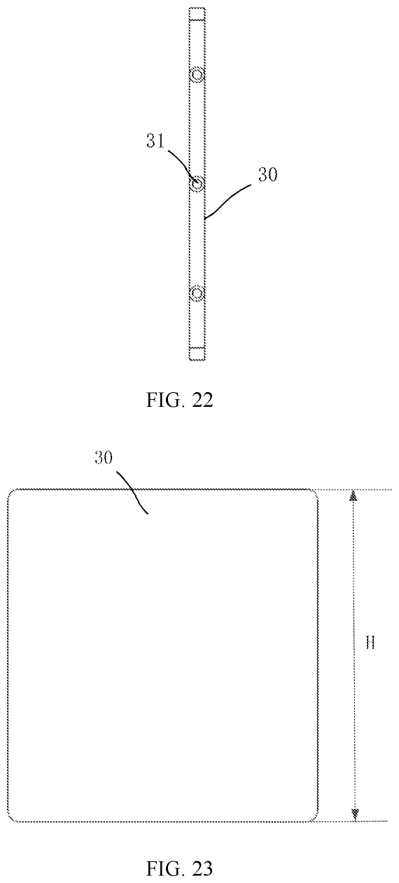

In one possible embodiment, as shown in FIG. 20 and FIG. 22, the interior of a bracket 30 is a hollow structure, and a plurality of weight-reducing holes 31 is provided in the bracket 30 to reduce the weight of the bracket 30, thereby reducing the weight of the battery cell assembly. The weight-reducing hole 31 may be a circular hole or a waist-shaped hole. Of course, the weight-reducing hole 31 may also have other shapes as long as the weight of the bracket 30 can be reduced, which is not specifically limited here.

In one possible embodiment, as shown in FIG. 2 and FIG. 3, a battery cell assembly provided by the present embodiment further includes a protective frame 40, which is wrapped around the outer sides of several battery cell modules 20, and the inner wall of the protective frame 40 are bonded to the several battery cell modules 20 by an adhesive. The protective frame 40 firmly fixes several battery cell modules 20 together, which not only fixes the battery cell modules 20 but also enhances the anti-shock capability of the battery cell modules 20.

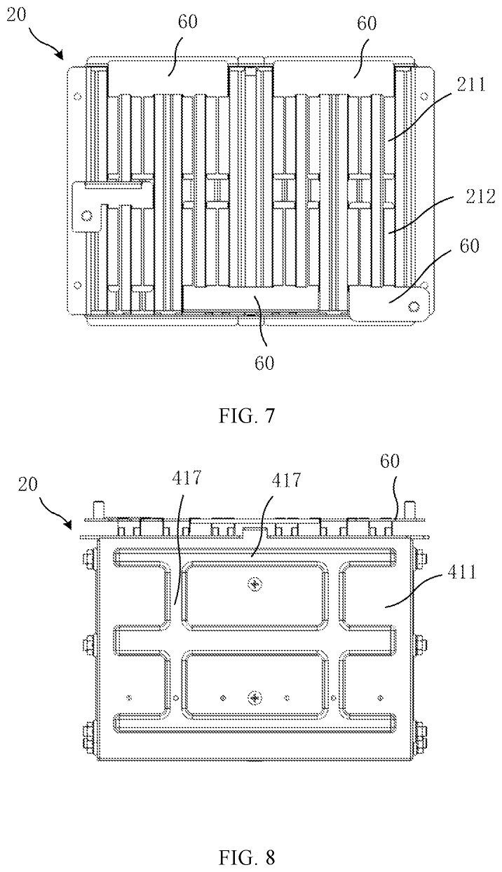

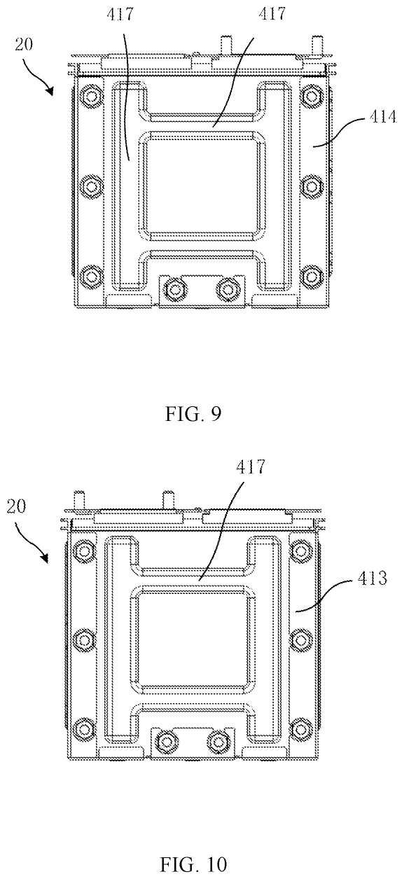

In one possible embodiment, as shown in FIG. 1 and FIG. 2, the protective frame 40 includes a plurality of end plates 41 which are connected to each other, and the surface of the end plates 41 facing the corresponding buffer component 22 is provided with a reinforcing rib 417; referring to FIG. 8, FIG. 9 and FIG. 10, the reinforcing rib 417 may be a structure in which several longitudinal protrusions and several transverse protrusions are staggered, and the number of longitudinal protrusions and the number of several transverse protrusions may be flexibly set according to the use requirements, and may be the same or not.

In one possible embodiment, the length of the reinforcing rib 417 is 80% to 95% of the length of a battery cell assembly, and the height of the reinforcing rib 417 is 70% to 90% of the height of the single battery cell 21. For example, the length of the reinforcing rib 417 may be 80%, 90% or 95% of the length of the battery cell assembly, and the height of the reinforcing rib 417 may be 70%, 80% or 90% of the height of the single battery cell 21.

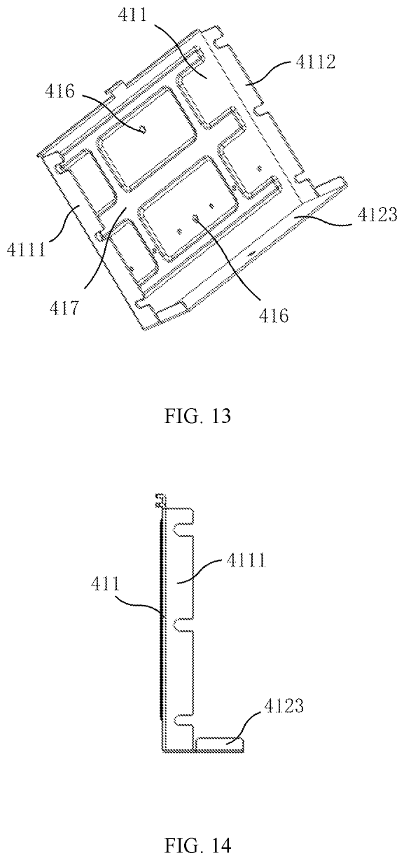

In one possible embodiment, referring to FIG. 1 and FIG. 2, the several end plates 41 are a front end plate 411, a first side end plate 413, a back end plates 412 and a second side end plate 414, that is, the protective frame 40 includes the front end plate 411, the first side end plate 413, the back end plate 412 and the second side end plate 414 which are connected end to end in sequence. Where, referring to FIG. 1 and FIG. 13, both ends of the front end plate 411 have a first flanging 4111 and a second flanging 4112 respectively, and both ends of the back end plate 412 have a third flanging 4121 and a fourth flanging 4122 respectively. The side of the first side end plate 413 facing the battery cell module 20 is in contact with the first flanging 4111 and the third flanging 4121, and the side of the second side end plate 414 facing the battery cell module 20 is in contact with the second flanging 4112 and the fourth flanging 4122.

In one possible embodiment, the first side end plate 413 may be connected to the first flanging 4111 and the third flanging 4121 by a screw or a rivet, and the first flanging 4111 and the third flanging 4121 are each provided with an opening slot for fixing the screw or rivet. The second side end plate 414 may be connected to the second flanging 4112 and the fourth flanging 4122 by a screws or a rivet, and the second flanging 4112 and the fourth flanging 4122 are each provided with an opening slot for fixing the screw or rivet.

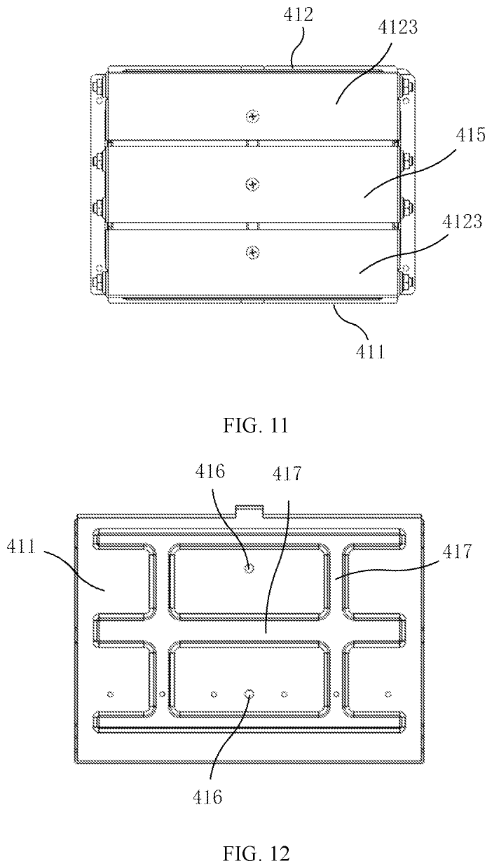

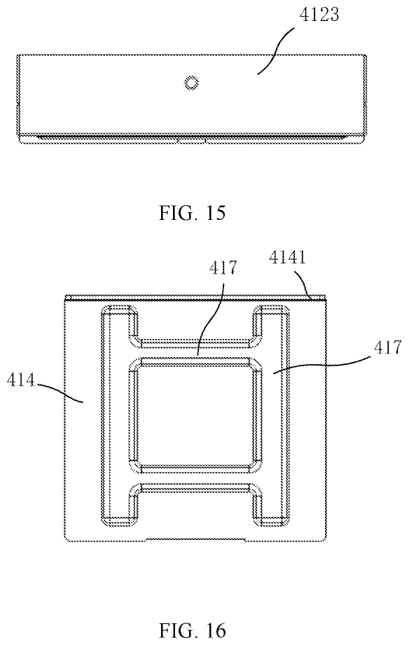

In one possible embodiment, as shown in FIG. 2 and FIG. 11, the protective frame 40 further includes a bottom end plate 415 located at the bottom of the battery cell module 20, that is, the bottom end plate 415 and the lead row 60 are located at opposite ends of the battery cell module 20 respectively. Referring to FIG. 13 and FIG. 14, each of the bottoms of the front end plate 411 and the back end plate 412 has a fifth flanging 4123. As shown in FIG. 2 and FIG. 11, the bottom end plate 415 is connected to the fifth flangings 4123, where both sides of the bottom end plate 415 are respectively connected with the fifth flanging 4123 of the back end plate 412 and the fifth flanging 4123 of the front end plate 411 by screws or rivets. Referring to FIG. 11 and FIG. 15, a screw hole is arranged on the fifth flanging 4123 to facilitate connection of the screw or rivet.

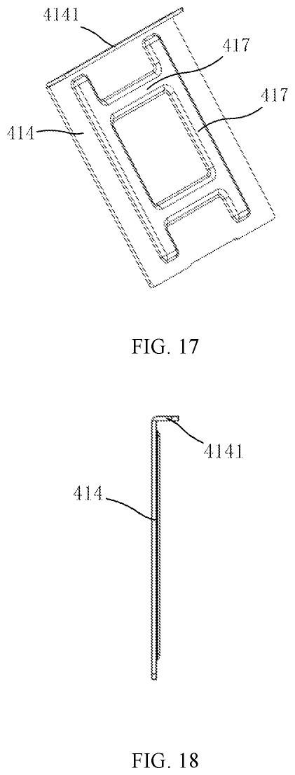

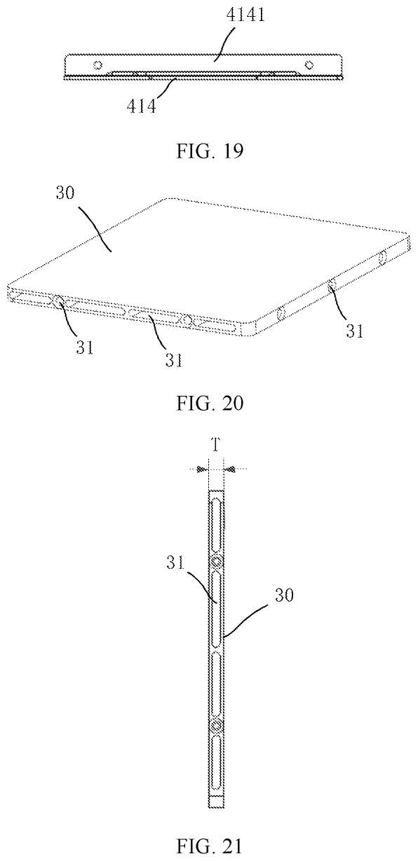

Referring to FIG. 16 and FIG. 17, an end of the first side end plate 413 facing away from the bottom end plate 415 and an end of the second side end plate 414 facing away from the bottom end plate 415 are each integrally connected to a sixth flanging 4141. As shown in FIG. 4 and FIG. 17, the sixth flanging 4141 is configured to connect with a tab frame plate 50, and an insulating plate 70 is connected to the tab frame plate 50. Referring to FIG. 18 and FIG. 19, the sixth flanging 4141 may be perpendicular to the first side end plate 413 or the second side end plate 414.

In one possible embodiment, as shown in FIG. 2, each of two ends of the bottom end plate 415 further has a seventh flanging 4151. Referring to FIG. 2 and FIG. 4, the seventh flangings 4151 at both ends of the bottom end plate 415 are respectively connected with the first side end plate 413 and the second side end plate 414 by screws.

Referring to FIG. 1 and FIG. 6, the buffer components 22 are arranged between the battery cell module 20 and the protective frame 40. That is, a buffer component 22 is arranged between the side of the battery cell module 20 facing the front end plate 411 and the front end plate 411; a buffer component 22 is arranged between the side of the battery cell module 20 facing the first side end plate 413 and the first side end plate 413; a buffer component 22 is arranged between the side of the battery cell module 20 facing the back end plate 412 and the back end plate 412; a buffer component 22 is arranged between the side of the battery cell module 20 facing the second side end plate 414 and the second side end plate 414; and a buffer component 22 is also arranged between the side of the battery cell module 20 facing the bottom side end plate 415 and the bottom side end plate 415.

In one possible embodiment, as shown in FIG. 2 and FIG. 12, an end plate 41 is further provided with an open pore 416. The open pore 416 is used for injecting an adhesive from the side of the end plate 41 facing away from the battery cell module 20 to the side of the end plate 41 facing the battery cell module 20, so that the battery cell module 20 and the end plate 41 are bonded with each other by the adhesive.

In one possible embodiment, the front end plate 411 and the back end plate 412 may be provided with open pores 416, and the number of the open pores 416 may be flexibly selected according to the use requirements, which is not specifically limited here.

In one possible embodiment, the adhesive may be glue.

The battery cell assembly provided by the present application includes several battery cell modules 20 that are electrically connected to each other, and the battery cell module 20 includes a plurality of single battery cells 21 that is electrically connected to each other, so that the modular production may reduce parts procurement cost and labor cost for assembly, simplify production processes, and improve the production efficiency of the battery cell assembly.

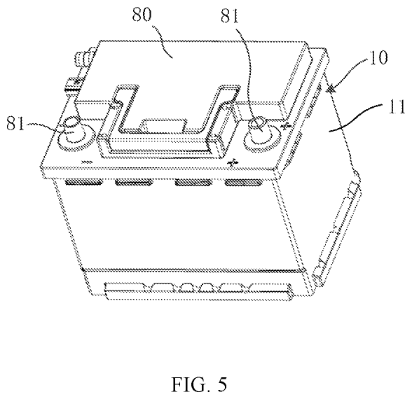

Referring to FIG. 4 and FIG. 5, the present application further provides a battery pack, which includes a case body 10 and the above-mentioned battery cell assembly, where the battery cell assembly is located in the case body 10.

In one possible embodiment, a box body 10 includes a bottom shell 11 and an upper cover 80 connected to the upper end of the bottom shell 11. The bottom shell 11 may be in a rectangular box body. The upper cover 80 is connected to a pair of terminals 81, which are electrically connected to the copper row respectively. One of the pair of terminals 81 is a positive terminal, the other is a negative terminal, and the pair of terminals 81 becomes the output interface of the battery. The bottom shell 11 and the upper cover 80 may adopt plastic materials, which have the effect of insulation protection.

In one possible embodiment, the upper end of the bracket 30 is abutted against the tab frame plate 50 to play a supporting role.

The present application further provides a battery pack, where the tab frame plate 50 is connected to the battery cell assembly, and the tab frame plate 50 may be a plate of plastic material and is connected to an insulating plate 70; and the insulating plate 70 is provided with a battery management system. The battery management system is a control system of the battery pack, monitoring the usage status of the battery pack. The upper cover 80 covers the insulating plate 70, and is connected to the upper end of the bottom shell 11.

It should be noted here that the numerical value and numerical range involved in the present application are an approximation, and there may be errors in a certain range due to the influence of the manufacturing process, and persons skilled in the art may consider these errors to be ignored.

In the description of the present application, it should be understood that the terms “center”, “length”, “width”, “thickness”, “top”, “bottom”, “upper”, “lower”, “left”, “right”, “front”, “back”, “vertical”, “horizontal”, “inner”, “outer”, “axial”, “circumferential” etc. that indicate the orientation or positional relationship are based on the orientations or positional relationships shown in the drawings, and they are only for the convenience of describing the present application and simplifying the description, rather than indicating or implying that the position or the original part referred to must have a specific orientation, and a specific structure and operation, so it should not be construed as limitation to the present application.

In addition, the terms “first” and “second” are only used for descriptive purposes, and should not be construed as indicating or implying relative importance or implying the number of indicated technical features. Therefore, a feature defined by “first”, or “second” may expressly or implicitly include one or more of the features. In the description of the present application, “several” means at least two, such as two, three, etc., unless otherwise expressly and specifically defined.

In the present application, unless otherwise expressly specified and limited, the terms “installation”, “connection”, “connect”, “fix”, etc. should be understood in a broad sense, for example, it may be fixed connection, detachable connection, or integrated; it may be mechanical connection or electrical connection or in communication with each other; it may be directly connected or indirectly connected through an intermediate medium; and it may make internal communication of two elements or interaction relationship between the two elements. For the person skilled in the art, the specific meanings of the above terms in the present application may be understood according to specific situations.

In the present application, unless otherwise expressly specified and limited, a first feature located “on” or “under” a second feature may include that the first feature is in direct contact with the second feature, or may include that the first feature and the second feature are not in direct contact but contacted through additional feature between them. In addition, the first feature being “on”, “over” and “above” the second feature includes the first feature being directly over and obliquely over the second feature, or simply means that the first feature has a higher horizontal height than the second feature. The first feature being “under”, “below” and “beneath” the second feature includes that the first feature is directly below and diagonally below the second feature, or simply means that the first feature has a lower horizontal height than the second feature.

Finally, it should be noted that the above embodiments are only used to illustrate the technical solutions of the present application, rather than limiting them; although detailed description has been made to the present application with reference to the aforementioned embodiments, the person skilled in the art should understand that they may still modify the technical solutions recorded in the aforementioned embodiments, or perform equivalent replacements on some or all of the technical features; however, these modifications or replacements do not make the essence of the corresponding technical solutions deviate from the scope of technical solutions in various embodiments of the present application.

What is claimed is:

1. A battery cell assembly, comprising: a bracket and several battery cell modules electrically connected with each other, wherein the bracket is arranged between two adjacent battery cell modules, each of the several battery cell modules comprises a plurality of single battery cells arranged side by side, and the plurality of single batteries is electrically connected with each other.

2. The battery cell assembly according to claim 1, wherein a height of the bracket is 7 mm to 10 mm lower than a height of the single battery cell;
the height of the bracket is 133 mm to 140 mm.

3. The battery cell assembly according to claim 1, further comprising a protective frame wrapped around outer sides of the several battery cell modules, and an inner wall of the protective frame is bonded with the several battery cell modules by an adhesive.

4. The battery cell assembly according to claim 3, further comprising buffer components, wherein the buffer components are arranged between the battery cell module and the bracket, between the battery cell module and the protective frame, and between two adjacent single battery cells, respectively.

5. The battery cell assembly according to claim 4, wherein a compression distance of the buffer component is greater than an expansion distance of the battery cell module.

6. The battery cell assembly according to claim 5, wherein the buffer component is a foam, and a thickness of the foam is 1.5 mm to 3 mm.

7. The battery cell assembly according to claim 1, wherein the bracket is an aluminum bracket; and/or
an interior of the bracket is a hollow structure; and/or
a thickness of the bracket is 5 mm to 8 mm.

8. The battery cell assembly according to claim 2, wherein the bracket is an aluminum bracket; and/or
an interior of the bracket is a hollow structure; and/or
a thickness of the bracket is 5 mm to 8 mm.

9. The battery cell assembly according to claim 3, wherein the bracket is an aluminum bracket; and/or
an interior of the bracket is a hollow structure; and/or
a thickness of the bracket is 5 mm to 8 mm.

10. The battery cell assembly according to claim 4, wherein the bracket is an aluminum bracket; and/or
an interior of the bracket is a hollow structure; and/or
a thickness of the bracket is 5 mm to 8 mm.

11. The battery cell assembly according to claim 5, wherein the bracket is an aluminum bracket; and/or
an interior of the bracket is a hollow structure; and/or
a thickness of the bracket is 5 mm to 8 mm.

12. The battery cell assembly according to claim 6, wherein the bracket is an aluminum bracket; and/or
an interior of the bracket is a hollow structure; and/or
a thickness of the bracket is 5 mm to 8 mm.

13. The battery cell assembly according to claim 4, wherein the protective frame comprises a plurality of end plates connected with each other, and a surface of each of the plurality of end plates facing a corresponding buffer component is provided with a reinforcing rib.

14. The battery cell assembly according to claim 13, wherein the end plate is further provided with an open pore.

15. The battery cell assembly according to claim 1, wherein the plurality of single battery cells is connected to each other in series through a lead row, and the several battery cell modules are connected to each other in series through the lead row.

16. A battery pack, comprising a box body and the battery cell assembly according to claim 1, the battery cell assembly being located inside the box body.
